(19) United States
(12) Patent Application Publication
(10) Pub. No.: US 2026/0256262 A1
(43) Pub. Date: Sep. 3, 2026

(54) CONTAINER

(71) Applicant: LA PRAIRIE GROUP AG, Zuerich (CH)

(72) Inventor: Winston LEE, Yongin-si, Gyconggi-do (KR)

(21) Appl. No.: 19/164,807

(22) PCT Filed: Mar. 7, 2024
(86) PCT No.: PCT/EP2024/055943

§ 371 Date: Sep. 12, 2025

(30) Foreign Application Priority Data
Mar. 15, 2023 (KR) 10-2023-0034096

(51) Int. Cl. A45D 34/06; A45D 40/22; A45D 40/24

(52) U.S. Cl. CPC A45D 34/06; A45D 40/22; A45D 40/24; A45D 2040/225; A45D 2200/057

(57) ABSTRACT

A container comprises a body having first and second accommodation spaces configured to accommodate individual substances therein, and an opening configured such that the first and second accommodation spaces are communicable with each other therethrough; a door in the body, configured to be capable of opening and closing the opening; a support installed in the body to be coupled to a part of the door and configured to be capable of supporting the door; and a release button coupled to one end of the support and installed on the body to release a coupled state between the support and the door when pressed. The door comprises a hinge shaft, a plate coupled thereto and an elastic material for applying rotational force to the hinge shaft.

### BACKGROUND OF THE INVENTION

### Field of the Invention

The present disclosure relates to a container, and more particularly, to a container which may hold individual substances separately, and may then mix these substances if needed.

### Description of the Related Art

In recent, interest in products which mix contents accommodated separately from each other if needed is growing. For this purpose, a container which may maintain various combinations of fluids, powders, pastes, etc. accommodated in a separated state in the container until a user decides to mix and utilize these contents is required.

Such a type of container may have an advantage in extension of the shelf life of a product, and may increase product efficiency compared to a product in which contents are mixed before shipping, in that the container may store the respective contents separately before being used. Therefore, such a type of container may be efficiently used in the fields of cosmetic creams and lotions, skin cleaners, shampoos, conditioners, and hair coloring.

In general, conventional containers are formed in a structure in which a user screws mechanisms together, or a driving force is used to cause the mechanisms to perform mixing of contents.

In the above structure, the user needs to apply considerable power to mix the contents, and may thus feel very uncomfortable. Further, in order to mix the contents using separate driving force, the container may have a complicated structure, and thus, it may be difficult to manufacture and manage the container.

Therefore, development of a container, which stably accommodates individual contents separately, allows a user to more conveniently mix the contents if needed, and has a relatively simple structure so as to be more easily manufactured and managed, is required.

### RELATED ART DOCUMENT

### Patent Document

Korean Patent Laid-open Publication No. 10-2014-0024254 (Publication Date: Feb. 28, 2014)

### SUMMARY OF THE INVENTION

Therefore, the present disclosure has been made in view of the above problems of containers which may mix contents accommodated separately therein if needed.

Concretely, it is an object of the present disclosure to provide a container which may mix substances accommodated individually therein through simple user operation.

It is another object of the present disclosure to provide a container which may hold substates in a separated state, and may perform a process of mixing these substances through a simple structure if needed.

Aspects achieved by the present disclosure are not limited to the above-described aspects, and other aspects of the present disclosure will be set forth in part in the description which follows and in part will become apparent to those skilled in the art upon examination of the following or may be learned from practice of the disclosure.

In accordance with the present disclosure, the above and other objects can be accomplished by the provision of a container including a body having a first accommodation space and a second accommodation space configured to accommodate individual substances therein, respectively, and an opening configured such that the first accommodation space and the second accommodation space are communicable with each other therethrough, a door installed in the body to be capable of opening and closing the opening, a support installed in the body to be coupled to a part of the door, and configured to be capable of supporting the door, and a release button coupled to one end of the support, and installed on the body to release a coupled state between the support and the door when pressed, wherein the door includes a hinge shaft installed on the body such that the door is rotatable around the hinge shaft, a plate provided in a plate form, and coupled to the hinge shaft to be capable of covering the opening depending on rotation of the door around the hinge shaft, and an elastic part including an elastic material, supported by the body while being coupled to the hinge shaft, and configured to apply rotational force to the hinge shaft through elasticity.

Here, the door may further include a sealing part including an elastic material, and formed on the plate to be capable of sealing a circumference of the opening when the plate covers the opening.

Further, the elastic part and the sealing part may be formed integrally.

Further, the elastic part may be disposed to be biased to an upper end of the hinge shaft.

Further, the sealing part may be disposed on one surface of the plate, and the elastic part may extend from the sealing part to a remaining surface of the plate by passing through the plate.

Further, the support may include a plurality of support teeth formed in a length direction, and the door may further include a plurality of door teeth formed to be engageable with the support teeth.

Further, some of the door teeth may be formed to be pushed in a direction of rotation of the door around the hinge shaft by the support teeth when the support is pressed by the release button.

Further, the release button may be disposed at an upper end of the body, and may move the support downwards in an axial direction when pressed.

Further, the container may further include a dispenser tube installed to extend from a lower end to an upper end of the body so as to be capable of inhaling the substance accommodated in at least one of the first accommodation space or the second accommodation space, and a dispenser coupled to an upper end of the dispenser tube so as to be capable of discharging the substance inhaled into the dispenser tube outside when pressed.

Further, an injection hole may be formed in each of lower parts of the first accommodation space and the second accommodation space of the body.

Further, the container may further include a base coupled to the body to cover a lower part of the body.

Further, the base may include sealing protrusions inserted into the respective injection holes, respectively, to be capable of sealing the injection holes when the base is coupled to the body.

Moreover, the respective sealing protrusions for the first accommodation space and the second accommodation space may be formed to have equal specifications.

Technical solutions of the present disclosure are not limited to the above-described technical solutions, and other technical solutions of the disclosure will be set forth in part in the description which follows and in part will become apparent to those skilled in the art upon examination of the following or may be learned from practice of the disclosure.

### Advantageous Effects

The effects of a container according to the present disclosure are as follows.

According to at least one of the embodiments of the present disclosure, an opening between a first accommodation space and a second accommodation space may be opened by pressing a release button, and thus, substances individually accommodated in the first accommodation space and the second accommodation space may be mixed with each other by simple user operation, and the container may be more conveniently used.

Further, according to at least one of the embodiments of the present disclosure, the opening may be opened through elasticity of an elastic part without a complicated power transmission mechanism, and thus, a process of separately accommodating the substances in the container and mixing the substances if needed may be performed through a simplified structure, and the container may be more easily manufactured and managed.

An additional range of applicability of the present disclosure will become apparent from the following detailed description. However, various modifications and variations of the present disclosure will become apparent to those skilled in the art within the spirit and scope of the present disclosure, and therefore, it is to be understood that the detailed description and specific embodiments, such as preferred embodiments, of the present disclosure will be given by way of illustrative examples of the present disclosure.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view of a container according to one embodiment of the present disclosure;

FIG. 2 is an exploded perspective view illustrating the state in which an upper cap is separated from the container shown in FIG. 1;

FIG. 3 is an exploded perspective view illustrating the state in which main components are separated from each other in the container shown in FIG. 2;

FIGS. 4 and 5 are sectional views illustrating a first accommodation space and a second accommodation space formed in a body of the container according to one embodiment of the present disclosure;

FIGS. 6 and 7 are longitudinal-sectional views illustrating a door configured to cover an opening in the container according to one embodiment of the present disclosure;

FIGS. 8 and 9 are views illustrating the states in which the opening is opened and closed by the door in the container according to one embodiment of the present disclosure; and

FIGS. 10 to 12 are perspective views illustrating the door, a support, and a release button in more detail in the container according to one embodiment of the present disclosure.

### DETAILED DESCRIPTION OF THE INVENTION

Hereinafter, reference will now be made in detail to preferred embodiments of the present disclosure, examples of which are illustrated in the accompanying drawings and described below. In the following description of the present disclosure, a detailed description of known functions and configurations incorporated herein will be omitted when it may make the subject matter of the present disclosure rather unclear.

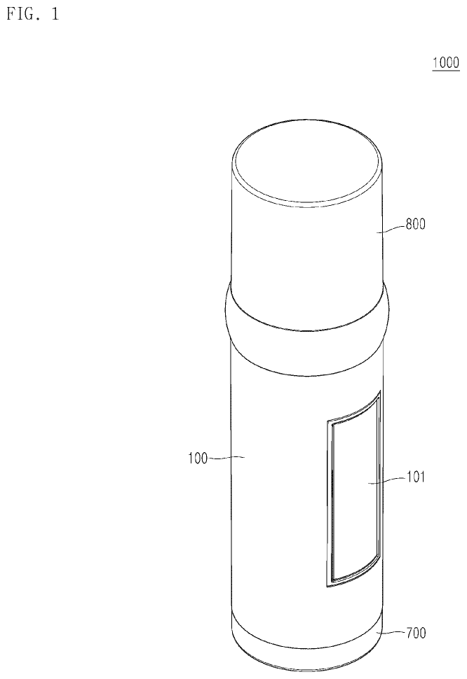

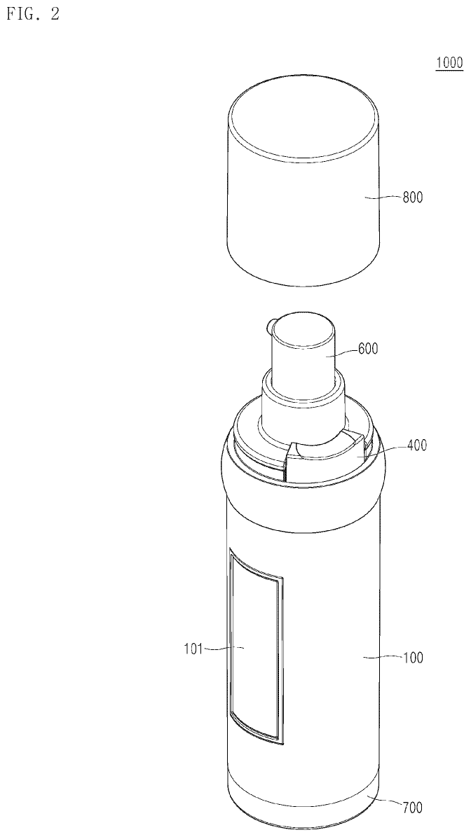

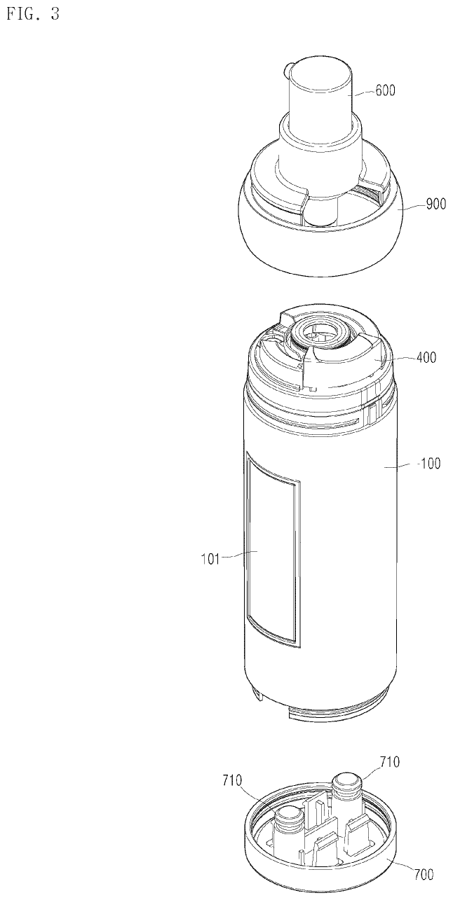

FIG. 1 is a perspective view of a container 1000 according to one embodiment of the present disclosure. FIG. 2 is an exploded perspective view illustrating the state in which an upper cap 800 is separated from the container 1000 shown in FIG. 1. FIG. 3 is an exploded perspective view illustrating the state in which main components are separated from each other in the container 1000 shown in FIG. 2.

Referring to FIGS. 1 to 3, the schematic structure of the container 1000 according to one embodiment of the present disclosure will be described first.

The container 1000 according to this embodiment may be configured to accommodate specific substances therein and to discharge the accommodated substance to the outside if needed.

For this purpose, the container 1000 according to this embodiment may include the body 100 configured to accommodate the specific substances therein. That is, accommodation spaces are formed in the body 100, and the specific substances may be accommodated in the accommodation spaces.

In this case, a transparent or translucent window 101 may be formed on one part of the body 100, so that a user may check the state of the substances accommodated in the body 100 through the window 101.

Further, a dispenser 600 is coupled to one part of the body 100, and may discharge the substances accommodated in the body 100 to be used if needed. That is, when the user uses the substances accommodated in the container 100, the user may operate the dispenser 600 to discharge the corresponding substances.

In this case, the dispenser 600 is not limited to the structure shown in the drawings, and may be variously formed to include a separate pumping structure, a pressure structure, or the like. Further, the dispenser 600 may be connected to a dispenser tube 500, which will be described below, so as to be capable of inhaling the substances located even at the lower end of the body 100.

Further, it is necessary to prevent unnecessary operation of the dispenser 600 when the user does not use the substances accommodated in the container 1000. In the case that the dispenser 600 is exposed to the outside, the substances accommodated in the container 1000 may be discharged regardless of user intention due to unintentional pressing of the dispenser 600.

Therefore, the container 1000 according to this embodiment may be configured such that the upper cap 800 is coupled to the body 100 so as to cover the dispenser 600, and the upper cap 800 is removed from the body 100 so as to expose the dispenser 600 when the user wants to use the substances accommodated in the container 1000.

Further, a base 700 may be coupled to another part of the body 100 opposite to the part thereof to which the dispenser 600 is coupled. The base 700 may form the bottom surface of the container 1000 so as to allow the container 1000 to maintain a stable state when the container 1000 is stored.

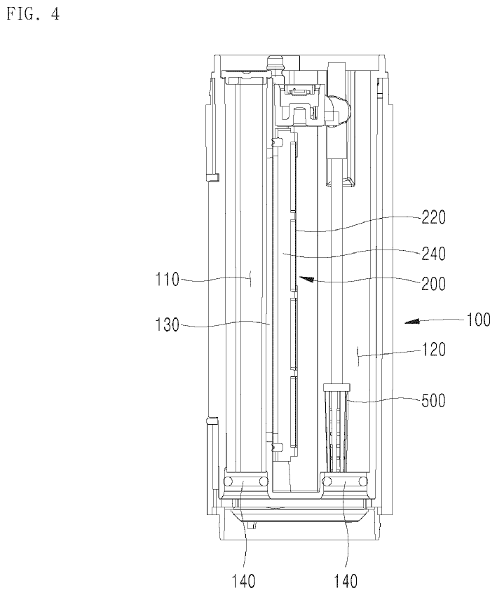

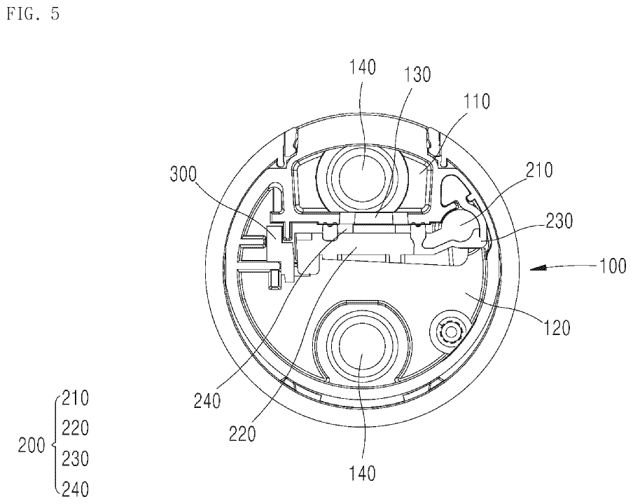

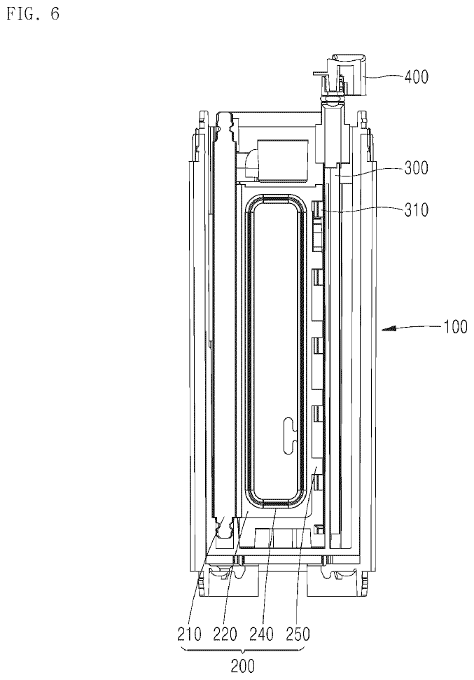

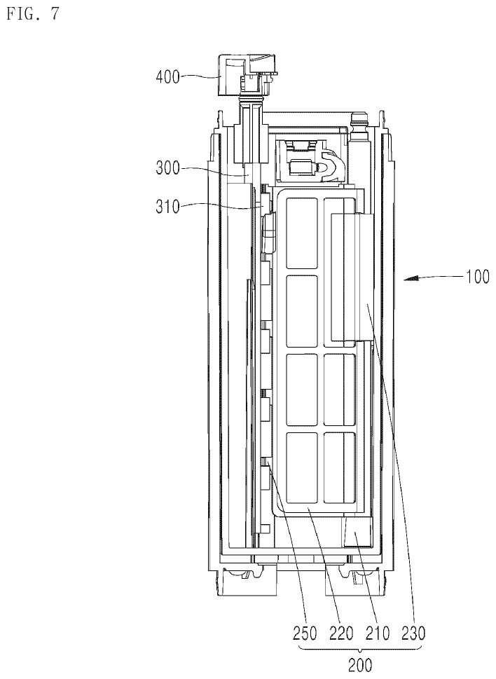

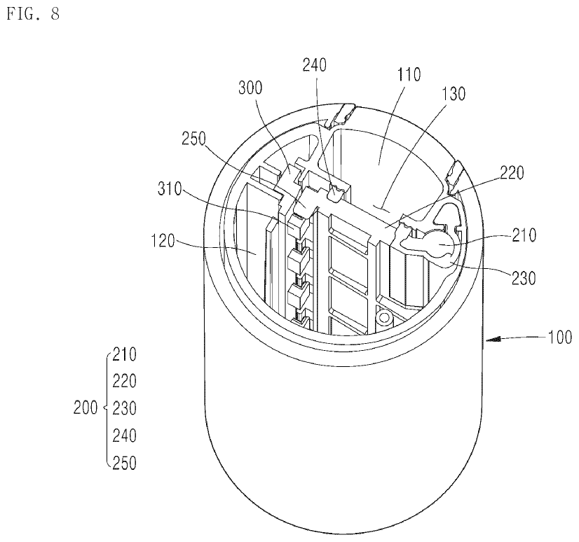

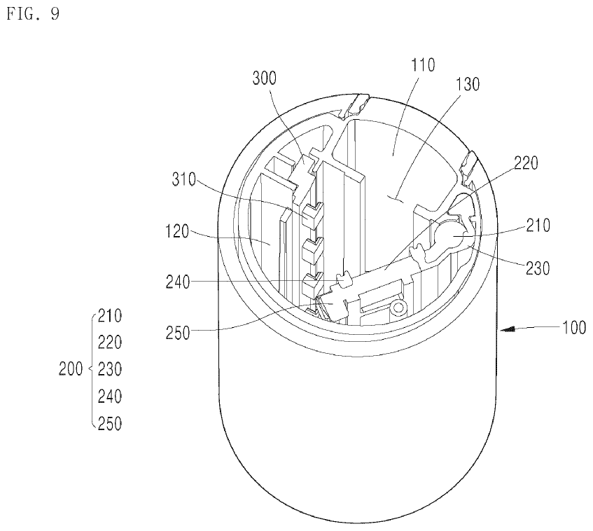

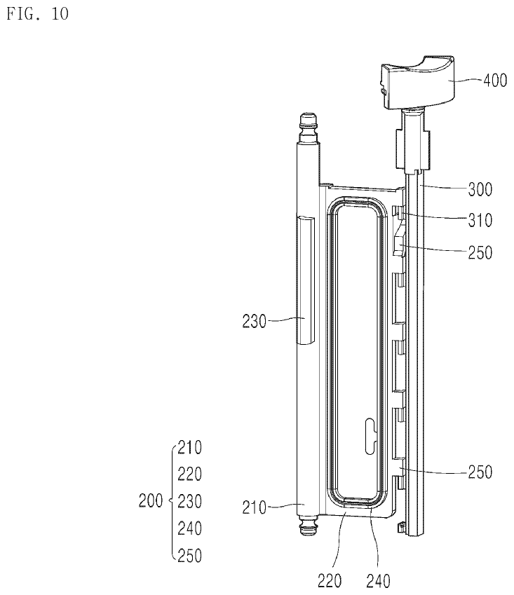

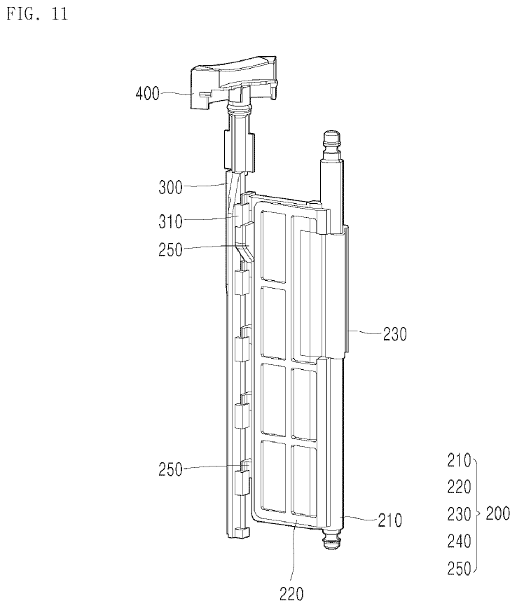

FIGS. 4 and 5 are sectional views illustrating a first accommodation space 110 and a second accommodation space 120 formed in the body 100 of the container 1000 according to one embodiment of the present disclosure. FIGS. 6 and 7 are longitudinal-sectional views illustrating a door 200 configured to cover an opening 130 in the container 1000 according to one embodiment of the present disclosure. FIGS. 8 and 9 are views illustrating the states in which the opening 130 is opened and closed by the door 200 in the container 1000 according to one embodiment of the present disclosure. FIGS. 10 to 12 are perspective views illustrating the door 130, a support 300, and a release button 400 in more detail in the container 1000 according to one embodiment of the present disclosure.

The detailed structure of the container 1000 according to one embodiment of the present disclosure will be additionally described with reference to FIGS. 4 to 10. Further, FIGS. 1 to 3 will be also referred to in the description of the container 1000 according to this embodiment.

The container 1000 according to one embodiment of the present disclosure includes the body 100, the door 200, the support 300, and the release button 400. In this case, the door 200 includes a hinge shaft 210, a plate 220, and an elastic part 230.

The first accommodation space 110 and the second accommodation space 120 configured to accommodate individual substances, respectively, are formed in the body 100, and the opening 130 through which the first accommodation space 110 and the second accommodation space 120 may communicate with each other is formed in the body 100.

That is, the first accommodation space 110 and the second accommodation space 120 may be separately formed in the body 100, so that specific substances are individually accommodated in the first accommodation space 110 and the second accommodation space 120.

Here, the substance accommodated in the first accommodation space 110 may be a liquid, a gas, or a combination of a liquid and a gas. Such a substance may include, for example, a water-based liquid, an alcohol-based liquid, an oil-based liquid, a petroleum-based ointment, a viscous liquid, such as a gel, an oil or an ointment, or the like.

Further, the substance accommodated in the second accommodation space 120 may be a substance which is mixed with the substance accommodated in the first accommodation space 110, but in which maintaining the mixed state therebetween for a long time has been determined to be undesirable.

In relation to these substances, the container 1000 according to this embodiment may be usefully applied to the fields of cosmetic creams and lotions, skin cleaners, shampoos, conditioners, and hair coloring, and application of the container 100 to functional cosmetics will be described below as one example.

Recently, it is difficult for cosmetics including an emulsion made up of general ingredients to satisfy user demands for various functional properties, and in order to satisfy these user demands, many products configured such that functional ingredients, such as caviar ingredients, or vitamin ingredients, are capable of being mixed with an emulsion are on the market.

When a user uses a cosmetic product in which functional ingredients are mixed with an emulsion, specific ingredients mixed with the emulsion naturally affect the skin and may thus satisfy various user demands.

However, when the mixed state of the functional ingredients, such as caviar ingredients or vitamin ingredients, with the emulsion is maintained for a long time, oxidation or the like occurs and may thus deteriorate the functional ingredients.

Therefore, the cosmetic product in which the functional ingredients are mixed with the emulsion has a relatively short shelf life, and is subject to a restriction in that it should be used as quickly as possible.

However, in the case that the functional ingredients, such as caviar ingredients or vitamin ingredients, are stored in a capsule form to be separated from the emulsion, and are mixed with the emulsion by melting the surfaces of the capsules if needed, the shelf life of the product may be extended and product efficiency may be increased.

Therefore, the container 1000 according to this embodiment has the first accommodation space 110 and the second accommodation space 120 formed in the body 100 to accommodate individual substances, respectively.

Further, the opening 130 may be formed between the first accommodation space 110 and the second accommodation space 120, and the substances accommodated in the first accommodation space 110 and the second accommodation space 120 may be mixed with each other through the opening 130 if needed.

The door 200 is installed in the body 100 so as to open and close the opening 130, and the door 200 may close the opening 130 in the state in which it is necessary to separately store the substance accommodated in the first accommodation space 110 and the substance accommodated in the second accommodation space 120, and may open the opening 130 when the user wants to mix the substance accommodated in the first accommodation space 110 and the substance accommodated in the second accommodation space 120.

The support 300 is installed in the body 100 to be coupled to a part of the door 200 so as to support the door 200, movement of the door 200 may be limited when the door 200 is coupled to the support 300, and the door 200 may be in a movable state when coupling of the door 200 to the support 300 is released.

Therefore, in the state in which the door 200 closes the opening 130, the door 200 is coupled to the support 300 so that the closed state of the opening 130 by the door 200 may be stably maintained.

On the other hand, in order to open the opening 130, coupling of the door 200 to the support 300 is released so that the door 200 may be moved in a direction of opening the opening 130.

The release button 400 is installed on the body 100 to be coupled to an end of the support 300 so as to release the coupled state between the door 200 and the support 300 when pressed, and the coupled state between the door 200 and the support 300 may be changed by operating the support 300 through the release button 400.

That is, in the state in which the support 300 and the door 200 are coupled to each other and thus the substances accommodated in the first accommodation space 110 and the second accommodation space 120 are separately stored, when the user presses the release button 400, coupling between the support 300 and the door 200 may be released, and the container 100 may be changed into the state in which the substances accommodated in the first accommodation space 110 and the second accommodation space 120 are capable of being mixed with each other.

Although coupling between the support 300 and the door 200 is released, a separate pressure needs to be applied to the door 200 so as to move the door 200 in the direction of opening the opening 130.

In this regard, the structure of the door 200 will be described in detail.

The hinge shaft 210 is one part of the door 200 which is installed on the body 100 such that the door 200 is rotatable around the hinge shaft 210, and the door 200 may be rotated around the hinge shaft 210. Thereby, when the door 200 is rotated around the hinge shaft 210 in the state in which coupling between the support 300 and the 300 is released, the opening 130 may be opened.

The plate 220 is one part of the door 200 which is provided in a plate form and coupled to the hinge shaft 210 and is capable of covering the opening 130 depending on rotation of the door 200 around the hinge shaft 210, and the plate 220 may cover and thus close the opening 130 in normal times, and may be spaced apart from the opening 130 and thus open the opening 130 when the door 200 is rotated around the hinge shaft 210.

In this case, the plate 220 may be formed in a plate structure having a planar area which is equal to or greater than the area of the opening 130, and may include a rib structure so as to maintain a designated rigidity.

The elastic part 230 is one part of the door 200 which includes an elastic material, is supported by the body 100 while being coupled to the hinge shaft 210 elastic part 230, and applies rotational force to the hinge shaft 210 through elasticity.

In this case, the elastic material refers to a material which, in a state deformed by external force, may return to an original state thereof when the external force is removed therefrom, and may include one of various materials including rubber, silicone, synthetic resins, and combinations thereof.

As shown in FIG. 8, in the state in which the door 200 closes the opening 130, the elastic part 230 may be supported by the body 100 while a part of the elastic part 230 is folded. Therefore, the elastic part 230 may be in the state of having elasticity to unfold the folded part thereof.

Further, as shown in FIG. 9, when coupling between the support 300 and the door 200 is released, the elastic part 230 may be unfolded by the above-described elasticity. Thereby, as the elastic part 230 is unfolded, the elastic part 230 may apply the rotational force to rotate the hinge shaft 210, and the door 200 coupled to the hinge shaft 210 may also be rotated around the hinge shaft 210 to open the opening 130.

In the container 1000 according to one embodiment of the present disclosure, since the opening 130 between the first accommodation space 110 and the second accommodation space 120 may be opened by pressing the release button 400, the substances individually accommodated first accommodation space 110 and the second accommodation space 120 are mixed with each other through simple user operation, and thus, the container 1000 may be more conveniently used.

Further, in the container 1000 according to one embodiment of the present disclosure, since the opening 130 may be opened through elasticity of the elastic part 230 without a complicated power transmission mechanism, a process of separately accommodating the substances in the container 1000 and mixing the substances if needed is performed through a simplified structure, and thus, the container 1000 may be more easily manufactured and managed.

In the container 1000 according to one embodiment of the present disclosure, the door 200 may further include a sealing part 240 which includes an elastic material and is formed on the plate 220 so as to seal the circumference of the opening 130 when the plate 220 covers the opening 130.

That is, as shown in FIGS. 4 to 6, the sealing part 240 having a shape corresponding to the shape of the opening 130 may be disposed on a part of the plate 220 facing the opening 130. Thereby, when the door 200 closes the opening 130, the sealing part 240 is pressed against the circumference of the opening 130 by elasticity, and thus, the sealed state of the opening 130 may be maintained.

In this way, in the container 1000 according to one embodiment of the present disclosure, the door 200 may further include the sealing part 240 so as to seal the opening 130, and thereby, the separate stored state of the substances accommodated in the first accommodation space 110 and the second accommodation space 120 may be more stably maintained.

In the container 1000 according to one embodiment of the present disclosure, the elastic part 230 and the sealing part 240 may be integrally formed. In this case, the elastic part 230 and the sealing part 240 may be formed on the door 200 through an insert injection method or the like.

As described above, it may be easy to integrally form the elastic part 230 and the sealing part 240 in that both the elastic part 230 and the sealing part 240 include an elastic material.

Particularly, as described above, in order to rotate the door 200 through elasticity of the elastic part 230, it may be advantageous to increase the contact area between the elastic part 230 and the door 200 so as to apply elasticity of the elastic part 230 to a large area of the door 200.

However, in that there is a limit in increasing the area of the elastic part 230 depending on the structure of the container 1000, it may be desirable that elasticity of the elastic part 230 be transmitted to the door 200 through the sealing part 240 formed integrally with the elastic part 230.

Further, in that a gap may occur between the door 200 and the elastic part 230 during a process of folding and unfolding the elastic part 230, it may be desirable that the elastic part 230 be formed integrally with the sealing part 240 in order to prevent the elastic part 230 from being separated from the door 200.

In this way, in the container 1000 according to one embodiment of the present disclosure, the elastic part 230 is formed integrally with the sealing part 240, and thereby, rotation of the door 200 through the elastic part 230 may be more smoothly performed and separation of the elastic part 230 from the door 200 may be effectively prevented.

In the container 1000 according to one embodiment of the present disclosure, the elastic part 230 may be disposed to be biased to the upper end of the hinge shaft 210.

As described above, considering only elasticity to rotate the door 200, it may be desirable that the elastic part 230 be disposed in all sections of the hinge shaft 210 in the length direction.

However, the elastic part 230 disposed in all sections of the hinge shaft 210 is overused and may thus increase manufacturing cost, and it may be difficult to assemble the door 200 having the elastic part 230 adhered thereto with the body 100 in a situation in which the door 200 and the elastic part 230 are pre-produced through the insert injection method or the like.

Therefore, it is necessary to consider that the elastic part 230 is disposed in only some optimum sections of the hinge shaft 210 in the length direction. Particularly, a more desirable disposition of the elastic part 230 may be determined depending on through which part, among the upper and lower parts of the body 100, the door 200 having the elastic part 230 adhered thereto is assembled with the body 100.

In this case, in consideration of sagging of the door 200 due to the weight thereof, it may be desirable that the elastic part 230 be disposed to be biased to the upper end of the hinge shaft 210 rather than the lower end of the hinge shaft 210, as shown in FIG. 7.

In this way, in the container 1000 according to one embodiment of the present disclosure, the elastic part 230 is disposed to be biased to the upper end of the hinge shaft 210, and thus, the manufacturing cost of the container 1000 may be reduced, assemblability of the container 1000 may be improved, and sagging of the door 200 due to the weight thereof may be minimized.

In the container 1000 according to one embodiment of the present disclosure, the sealing part 240 may be disposed on one surface of the plate 220, and the elastic part 230 may extend from the sealing part 240 to the other surface of the plate 220 by passing through the plate 220.

As shown in FIGS. 5 to 7, the sealing part 240 needs to be disposed on one surface of the plate 220 facing the opening 130. The elastic part 230 formed integrally with the sealing part 240 needs to be supported by the body 100 while a part of the elastic part 230 is folded.

Here, in the case that the elastic ember 230 is disposed the surface of the plate 220 on which the sealing part 240 is disposed, the door 200 and the elastic part 230 may not be effectively pressed against with each other during the process of folding and unfolding the elastic part 230.

Therefore, it may be desirable that the elastic part 230 be disposed on the other surface of the plate 220 opposite to the surface of the plate 220 on which the sealing part 240 is disposed. For this purpose, the elastic part 230 formed integrally with the sealing part 240 may pass through the plate 220.

In this way, in the container 1000 according to one embodiment of the present disclosure, the sealing part 240 is disposed on one surface of the plate 220 and the elastic part 230 is disposed on the other surface of the plate 220, and thus, the pressed state of the sealing part 240 and the elastic part 230 against the door 200 may be more stably maintained.

In the container 1000 according to one embodiment of the present disclosure, the support 300 may include a plurality of support teeth 310 formed in the length direction. In this case, the door 200 may further include a plurality of door teeth 250 formed to be engageable with the support teeth 310.

As shown in FIGS. 10 to 12, the plurality of support teeth 310 may be intermittently formed on the support 310 in the length direction, and the plurality of door teeth 250 may be intermittently formed on a part of the door 200 facing the support 300 in the length direction.

Thereby, when the support teeth 310 and the door teeth 250 are located at the same heights, the support teeth 310 and the door teeth 250 may be engaged with each other so as to maintain the coupled state between the support 300 and the door 200.

Further, when the support teeth 310 are located in spaces between the door teeth 250 by pressing the release button 400, the engaged state between the support 300 and the door 200 may be released and the door 200 is converted into the state in which the door 200 is capable of opening the opening 130.

In this way, in the container 1000 according to one embodiment of the present disclosure, the support 300 and the door 200 are coupled through engagement between the support teeth 310 and the door teeth 250, and thus, the coupled state between the support 300 and the door 200 for opening and closing the opening 130 may be more appropriately controlled.

In the container 1000 according to one embodiment of the present disclosure, some of the door teeth 250 may be formed to be pushed in the direction of rotation of the door 200 around the hinge shaft 210 by the support teeth 310 when the support 300 is pressed by the release button 400.

As described above, when the door 200 is rotated by elasticity of the elastic part 230 after releasing the coupled state between the support 300 and the door 200, the door 200 may not be smoothly rotated due to resistance by the substances accommodated in the body 100.

Therefore, when the opening 130 is not opened enough, the substances accommodated in the first accommodation space 110 and the second accommodation space 120 may not be mixed with each other, and thus, the function of a container product may be deteriorated.

Therefore, when the coupled state between the support 300 and the door 200 is released by the user pressing the release button 400, it may be desirable that a pressure be applied to rotate the door 200 to some extent.

For this purpose, as shown in FIGS. 10 to 12, an inclined surface may be formed on some of the door teeth 250, so that a corresponding one of the support teeth 310 may press the door tooth 250 along the inclined surface and push the door tooth 250 in the direction of rotation of the door 200 around the hinge shaft 210 when the support 300 is pressed by the release button 400 and is moved.

Thereby, the door 200 is rotated around the hinge shaft 210 to some extent while the door tooth 250 is pushed, and is then more smoothly rotated around the hinge shaft 210 due to elasticity of the elastic part 230.

In this way, in the container 1000 according to one embodiment of the present disclosure, some of the door teeth 250 may be pushed by the support teeth 310 and, therefore, when the user presses the release button 400 so as to release the coupled state between the support 300 and the door 200, the opening 130 may be more smoothly opened by additionally applying a pressure to rotate the door 200.

In the container 1000 according to one embodiment of the present disclosure, the release button 400 may be disposed at the upper end of the body 100, and may move the support 300 downwards in the axial direction when the release button 400 is pressed. That is, as shown in FIGS. 2 and 3, the release button 400 configured to release the coupled state between the support 300 and the door 200 may be disposed at the upper end of the body 100.

For this purpose, a coupler 900 configured to support the dispenser 600 may be coupled to the upper part of the body 100, and the release button 400 may be exposed to the outside through an opening formed in a part of the coupler 900.

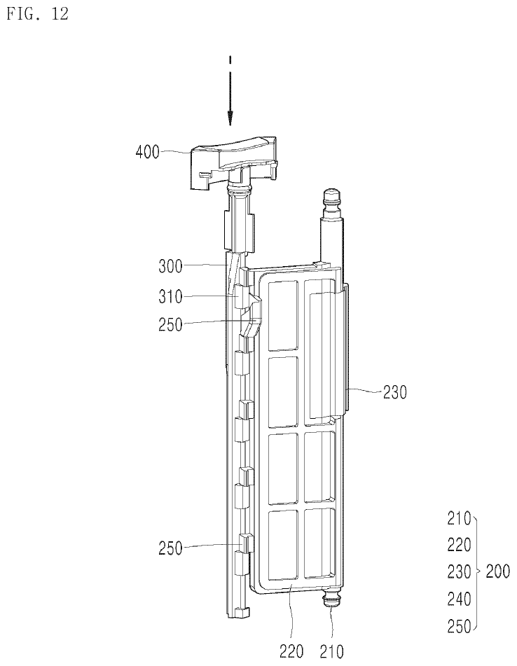

Further, as shown in FIG. 12, when the user presses the release button 400 disposed at the upper end of the body 100, the support 300 may be moved downwards in the axial direction. Thereby, the above-described engaged state between the support teeth 310 and the door teeth 250 may be released.

In that the release button 400 is operated by user power, pressing of the release button 400 from the upper part towards the lower part of the body 100 may be most convenient for user to apply great force.

Therefore, it may be desirable that the user be naturally induced to press the release button 400 from the upper part towards the lower part of the body 100 by disposing the release button 400 at the upper end of the body 100.

In this way, in the container 1000 according to one embodiment of the present disclosure, the release button 400 disposed at the upper end of the body 100 is configured to be pressed downwards, and thus, user operation to release the coupled state between the support 300 and the door 200 may be more easily performed.

The container 1000 according to one embodiment of the present disclosure may further include the dispenser tube 500 and the dispenser 600.

The dispenser tube 500 extends from the lower end to the upper end of the body 10, and may inhale the substance accommodated in at least one of the first accommodation space 110 or the second accommodation space 120.

That is, as shown in FIG. 4, the dispenser tube 500 may extend to the lower end of the body 100, and the substance located in the lower end of the body 100 may be inhaled into the dispenser tube 500. Further, the substance inhaled into the dispenser tube 500 may be transferred upwards in the length direction of the dispenser tube 500 by operation of the dispenser 600.

The dispenser 600 is coupled to the upper end of the dispenser tube 500, and may discharge the substance inhaled into the disperser tube 500 to the outside when the dispenser 600 is pressed.

That is, the user, who wants to use the substance accommodated in the container 1000, may press the dispenser 600, and thereby, the substance inhaled into the dispenser tube 500 may be transferred upwards and discharged to the outside of the dispenser 600.

In this way, the container 1000 according to one embodiment of the present disclosure may further include the dispenser tube 500 and the dispenser 600, and may smoothly discharge the substances accommodated in the body 100 if needed.

In the container 1000 according to one embodiment of the present disclosure, an injection hole 140 may be formed in each of the lower parts of the first accommodation space 110 and the second accommodation space 120. That is, specific substances may be injected into the first accommodation space 110 and the second accommodation space 120 through the respective injection holes 140 formed in the lower part of the body 100.

In the case of a product to which the container 1000 according to this embodiment is applied, it is necessary to inject the respective specific substances into the first accommodation space 110 and the second accommodation space 120 immediately after completion of manufacture of the container 1000 or during a process of manufacturing the container 1000.

In this case, since the dispenser 600 and the release button 400 are disposed at the upper part of the body 100, as described above, there may be a limit on formation of the injection holes 140, configured to inject the substances therethrough, in the upper part of the body 100.

Therefore, it may be desirable that the respective injection holes 140 of the first accommodation space 110 and the second accommodation space 120 be formed in the lower part of the body 100 which may comparatively secure a surplus space because the dispenser 600 and the release button 400 are not disposed at the lower part of the body 100.

In this way, in the container 1000 according to one embodiment of the present disclosure, the injection holes 140 are formed in the lower part of the body 100, and thus, interference of the formation positions of the injection holes 140 with other main elements may be minimized.

The container 1000 according to one embodiment of the present disclosure may further include the base 700 coupled to the body 100 so as to cover the lower part of the body 100.

Since elements, such as the injection holes 140, may be formed in the lower part of the body 100 and the substances are accommodated in the body 100, as described above, exposure of the lower surface of the body 100 directly to the outside is undesirable.

Further, when the product to which the container 1000 according to this embodiment is applied is stored, the container 100 needs to have a uniform bottom surface in order to erect the product.

Therefore, it may be desirable that the base 700 be coupled to the lower part of the body 100 so as to cover the lower surface of the body 100 and to uniformize the bottom surface of the container 1000.

In this way, the container 1000 according to one embodiment of the present disclosure may further include the base 700, thereby being capable of protecting the lower part of the body 100 and more easily storing the product to which the container 1000 is applied.

In the container 1000 according to one embodiment of the present disclosure, the base 700 may include sealing protrusions 710 inserted into the respective injection holes 410 so as to be capable of sealing the injection holes 410 when the base 700 is coupled to the body 100.

As described above, in the case that the injection holes 140 are formed in the lower part of the body 140, the substances accommodated in the first accommodation space 110 and the second accommodation space 120 may leak out through the injection holes 140. Particularly, when the product to which the container 1000 according to this embodiment is applied is stored upright, there is a risk of discharge of the substances through the injection holes 140 by gravity.

Therefore, it may be necessary to close the injection holes 140 so as to prevent the substances from being unnecessarily discharged, after the respective substances have been injected into the first accommodation space 110 and the second accommodation space 120.

Therefore, it may be desirable that the sealing protrusions 710 be formed on the base 700 so as to close the injection holes 140 naturally when the base 700 is coupled to the lower part of the body 100.

In this way, in the container 1000 according to one embodiment of the present disclosure, the sealing protrusions 710 formed on the base 700 close the injection holes 140, thereby being capable of preventing the substances accommodated in the first accommodation space 110 and the second accommodation space 120 from being unnecessarily discharged.

In the container 1000 according to one embodiment of the present disclosure, the respective sealing protrusions 710 for the first accommodation space 110 and the second accommodation space 120 may be formed to have the same specifications. Further, as shown in FIG. 3, the respective sealing protrusions 710 may be arranged on the plane of the base 700 symmetrically with each other.

As described above, in the case that the sealing protrusions 710 close the injection holes 140 naturally when the base 700 is coupled to the lower part of the body 100, when the specifications of the respective sealing protrusions 710 are different, the base 700 is capable of being coupled to the body 100 only in one direction, and the base 700 is not capable of being coupled to the body 100 in the opposite direction.

In this case, when the container 1000 according to this embodiment is assembled, the user needs to confirm the direction of the base 700 coupled to the body 100 at all times, and may thus be very uncomfortable.

Therefore, it may be desirable that the respective sealing protrusions 710 formed on the base 700 have the same specifications so that the base 700 is coupled to the body 100 only by inserting the sealing protrusions 710 into the injection holes 140 regardless of direction.

In this way, in the container 1000 according to one embodiment of the present disclosure, the specifications of the respective sealing protrusions 710 formed on the base 700 are the same, and thus, assemblability of the container 1000 may be further improved.

Although the exemplary embodiments of the present disclosure have been disclosed for illustrative purposes, those skilled in the art will appreciate that various modifications, additions and substitutions are possible, without departing from the scope and spirit of the disclosure as disclosed in the accompanying claims. Therefore, the scope of the present disclosure is defined not by the detailed description, but by the claims and their equivalents, and all variations within the scope o the claims and their equivalents are to be construed as being included in the present disclosure.

EXPLANATION OF REFERENCE NUMERALS AND MARKS

| | |
|---|---|
| 100: body | 101: window |
| 110: first | 120: second |
| accommodation space | accommodation space |
| 130: opening | 140: injection hole |
| 200: door | 210: hinge shaft |
| 220: plate | 230: elastic part |
| 240: sealing part | 250: door tooth |
| 300: support | 310: support tooth |
| 400: release button | 500: dispenser tube |
| 600: dispenser | 700: base |
| 710: sealing protrusion | 800: upper cap |
| 900: coupler | 100: container |

1.-13. (canceled)

14. A container, wherein the container comprises:
a body having a first accommodation space and a second accommodation space configured to accommodate individual substances therein, respectively, and an opening configured such that the first accommodation space and the second accommodation space are communicable with each other therethrough;
a door installed in the body, the door configured to be capable of opening and closing the opening;
a support installed in the body to be coupled to a part of the door, and configured to be capable of supporting the door; and
a release button coupled to one end of the support, and installed on the body to release a coupled state between the support and the door when pressed, wherein the door comprises:
a hinge shaft installed on the body such that the door is rotatable around the hinge shaft;
a plate provided in a plate form, and coupled to the hinge shaft to be capable of covering the opening depending on rotation of the door around the hinge shaft; and
an elastic part comprising an elastic material, supported by the body while being coupled to the hinge shaft, and configured to apply rotational force to the hinge shaft through elasticity.

15. The container of claim 14, wherein the door further comprises:
a sealing part comprising an elastic material, and formed on the plate to be capable of sealing a circumference of the opening when the plate covers the opening.

16. The container of claim 15, wherein the elastic part and the sealing part are formed integrally.

17. The container of claim 16, wherein the elastic part is disposed to be biased to an upper end of the hinge shaft.

18. The container of claim 16, wherein:
the sealing part is disposed on one surface of the plate; and
the elastic part extends from the sealing part to a remaining surface of the plate by passing through the plate.

19. The container of claim 14, wherein:
the support comprises a plurality of support teeth formed in a length direction; and
the door further comprises a plurality of door teeth formed to be engageable with the support teeth.

20. The container of claim 19, wherein some of the door teeth are formed to be pushed in a direction of rotation of the door around the hinge shaft by the support teeth when the support is pressed by the release button.

21. The container of claim 20, wherein the release button is disposed at an upper end of the body, and moves the support downwards in an axial direction when pressed.

22. The container of claim 1, wherein the container further comprises:
a dispenser tube installed to extend from a lower end to an upper end of the body so as to be capable of inhaling the substance accommodated in at least one of the first accommodation space or the second accommodation space; and
a dispenser coupled to an upper end of the dispenser tube so as to be capable of discharging the substance inhaled into the dispenser tube outside when pressed.

23. The container of claim 22, wherein an injection hole is formed in each of lower parts of the first accommodation space and the second accommodation space of the body.

24. The container of claim 23, wherein the container further comprises:
a base coupled to the body to cover a lower part of the body.

25. The container of claim 24, wherein the base comprises sealing protrusions inserted into the respective injection holes, respectively, to be capable of sealing the injection holes when the base is coupled to the body.

26. The container of claim 25, wherein the respective sealing protrusions for the first accommodation space and the second accommodation space are formed to have equal specifications.
